(19) United States
(12) Patent Application Publication
(10) Pub. No.: US 2011/0233835 A1
(43) Pub. Date: Sep. 29, 2011

(54) SHOCK ABSORBER

(75) Inventors: DONG-WEI ZHAO, Shenzhen City (CN); JIN-WEI XIAO, Shenzhen City (CN)

(73) Assignees: FU TAI HUA INDUSTRY (SHENZHEN) CO., LTD., ShenZhen City (CN); HON HAI PRECISION INDUSTRY CO., LTD., Tu-Cheng (TW)

(21) Appl. No.: 12/884,205

(22) Filed: Sep. 17, 2010

(30) Foreign Application Priority Data
Mar. 29, 2010 (CN) 201010134577.3

(51) Int. Cl. F16F 13/00; F16F 9/30

(52) U.S. Cl. 267/140.13; 188/268

(57) ABSTRACT

A shock absorber includes a cylinder defining a sliding hole, at least two sliders, absorbing particles filled in to the sliding hole, and a cap. The at least two sliders are slidably fitted in the sliding hole. The cap is connected to the sliding hole of the cylinder to prevent the sliders from sliding out of the sliding hole.

### BACKGROUND

1. Technical Field

The present disclosure relates to a shock absorber.

2. Description of the Related Art

Generally, shock absorbers are important parts of automobile and motorcycle suspensions, aircraft landing gear, and the supports for many industrial machines. There are several types of commonly-used shock absorbers. Though conventional shock absorbers satisfy basic requirements, a new type of absorber is still needed.

### BRIEF DESCRIPTION OF THE DRAWINGS

The components of the drawings are not necessarily drawn to scale, the emphasis instead being placed upon clearly illustrating the principles of a shock absorber. Moreover, in the drawings, like reference numerals designate corresponding parts throughout several views.

FIG. 1 is an isometric view of a shock absorber according to an exemplary embodiment.

FIG. 2 is an exploded, isometric view of the shock absorber of FIG. 1.

FIG. 3 is a cross section view of the shock absorber of FIG. 1, taken along the line III-III of FIG. 1.

FIG. 4 is similar to FIG. 3, except that the shock absorber is connected to a device.

### DETAILED DESCRIPTION

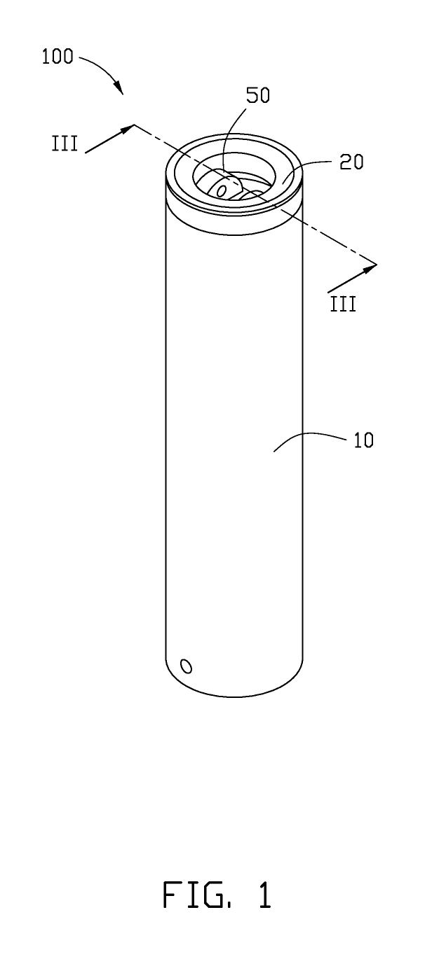

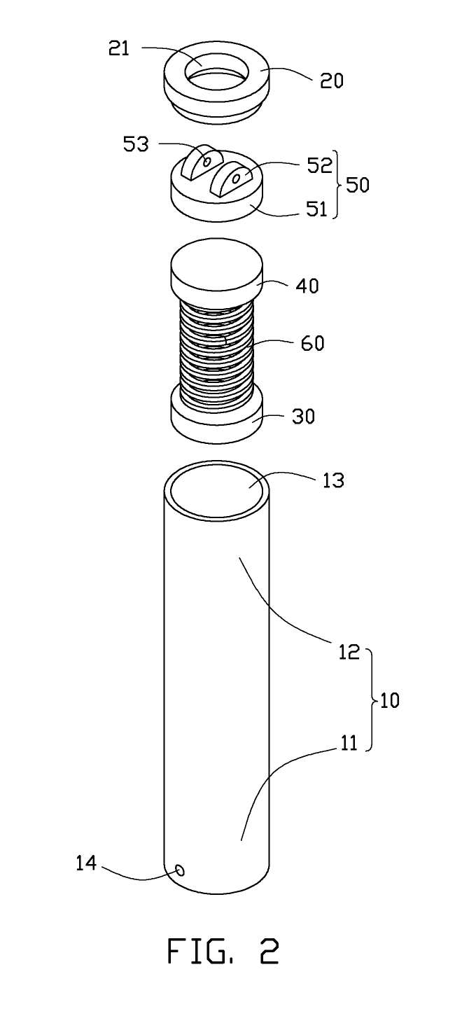

Referring to FIGS. 1 and 2, a shock absorber 100 according to an exemplary embodiment is illustrated. The shock absorber 100 includes a cylinder 10, a cap 20, and a number of sliders slidably fit in the cylinder 10. In the embodiment, the sliders include a first slider 30, a second slider 40, and a third slider 50.

The cylinder 10 includes a blind first end 11 and an open second end 12 at opposite ends thereof. The first end 11 defines a valve 14, and the second end 12 defines a sliding hole 13. The cap 20 is connected to the second end 12 of the cylinder 10 and defines a through hole 21 aligned with the sliding hole 13. The cap 20 is configured to prevent the sliders 30, 40 and 50 from sliding out of the sliding hole 13.

The first slider 30, the second slider 40, and the third slider 50 are orderly received in the sliding hole 13 of the cylinder 10. The third slider 50 includes a sliding portion 51 and two parallel fastening portions 52 protruding from a top surface of the sliding portion 51. The third slider 50 defines a fastening hole 53 spanning through both of the two fastening portions 52.

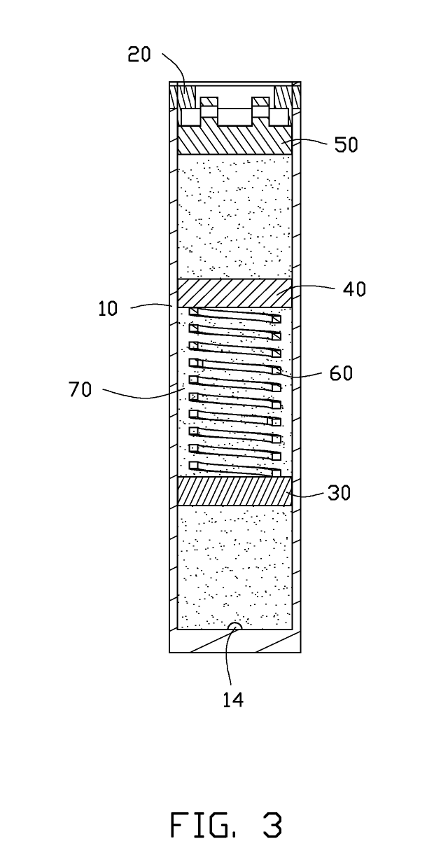

Referring to FIG. 3, the shock absorber 100 further includes a resilient member 60 and a number of absorbing particles 70, e.g., shock absorber oil. The resilient member 60 is positioned between the first slider 30 and the second slider 40, and the absorbing particles 70 are filled into the sliding hole 13 of the cylinder 10. The valve 14 is configured to allow filling the sliding hole 13 with the absorbing particles 70 or releasing the absorbing particles 70 from the sliding hole 13. In the embodiment, the resilient member 60 is a coiled spring.

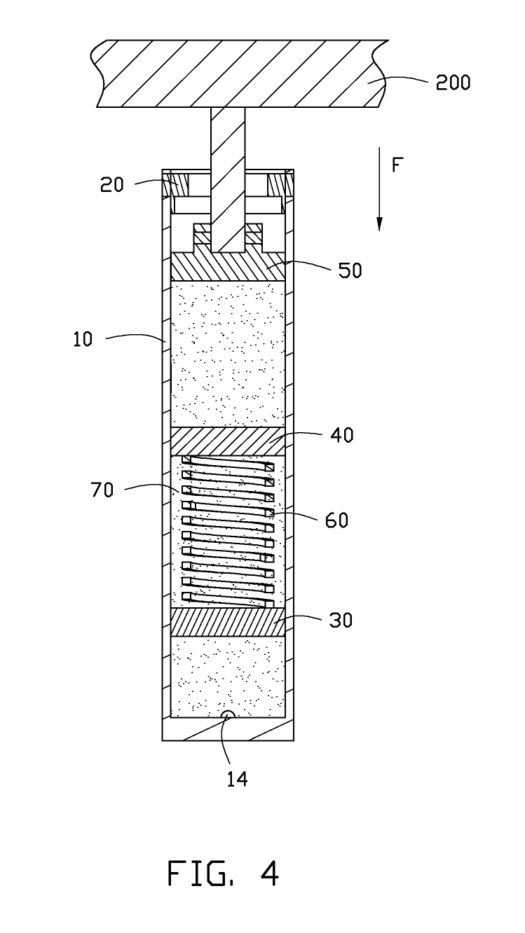

Referring to FIG. 4, a device 200 is connected to the third slider 50 through the through hole 21 of the cap 20. When a downward force F is applied to the device 200, the resilient member 60 and the absorbing particles 70 collectively drive the first slider 30, the second slider 40, and the third slider 50 to move to a balanced position under the drive of the force F. Thus, the shock absorber 100 absorbs energy of the force F.

Although the present disclosure has been specifically described on the basis of certain embodiments thereof, the disclosure is not to be construed as being limited to the described embodiments. Various changes or modifications may be made to the embodiments without departing from the scope and spirit of the disclosure.

What is claimed is:

1. A shock absorber comprising:
a cylinder defining a sliding hole;
at least two sliders slidably fit in the sliding hole;
absorbing particles filled into the sliding hole; and
a cap connected to the cylinder to prevent the sliders from sliding out of the sliding hole.

2. The shock absorber as described in claim 1, wherein the at least two sliders comprise a first slider, a second slider, and a third slider orderly fitted into the sliding hole of the cylinder.

3. The shock absorber as described in claim 2, further comprising a resilient member positioned between the second slider and the third slider.

4. The shock absorber as described in claim 3, wherein the resilient member is a coiled spring.

5. The shock absorber as described in claim 1, wherein the cylinder comprises a blind first end and an opposite second end defining the sliding hole, the first end defines a valve allowing insertion or removal of the absorbing particles.

6. The shock absorber as described in claim 5, wherein the cap is connected to the second end and defines a through hole aligned with the sliding hole.
